(19) United States
(12) Patent Application Publication
(10) Pub. No.: US 2026/0342730 A1
(43) Pub. Date: Oct. 29, 2026

(54) CONGESTION CONTROL (CC) FAST RECOVERY USING NETWORK INTERFACE CARD (NIC) TELEMETRY

(71) Applicant: Mellanox Technologies, Ltd., Yokneam (IL)

(72) Inventors: Yuval Shpigelman, Netanya (IL); Omer Shabtai, Tel Aviv (IL); Lior Maman, Herzliya (IL); Adi Horowitz, Lehavot Habashan (IL)

(21) Appl. No.: 19/192,772

(22) Filed: Apr. 29, 2025

(51) Int. Cl. H04L 47/11; H04L 43/106; H04L 47/122

(52) U.S. Cl. CPC H04L 47/11; H04L 43/106; H04L 47/122

(57) ABSTRACT

Technologies for fast-recovery congestion control are described. A first network device includes a network interface to send first packets of a flow of packets at a first transmission rate over a network to a second network device via a switch, and packet processing circuitry coupled to the network interface. The packet processing circuitry receives telemetry data collected by the second network device. The packet processing circuitry determines, using the telemetry data, a positive congestion indication of the flow of packets. The packet processing circuitry adjusts, using the positive congestion indication, the first transmission rate to a second transmission rate. The packet processing circuitry causes the network interface to send second packets of the flow of packets at the second transmission rate over the network to the second network device via the switch.

### TECHNICAL FIELD

At least one embodiment pertains to processing resources used for fast-recovery congestion control in packet communication networks. For example, at least one embodiment pertains to packet processing circuitry that can determine a positive congestion indication of the flow of packets using telemetry data and adjust the transmission rate accordingly.

### BACKGROUND

The modern data center is undergoing a transformative evolution driven by the explosive growth of machine learning (ML) and artificial intelligence (AI) workloads. Traditional compute- and storage-centric architectures are giving way to highly optimized, AI-focused infrastructures designed to meet the unprecedented demands for parallelism, low latency, and massive throughput. At the heart of this evolution is the convergence of high-performance computing (HPC) and cloud-native scalability. Cutting-edge data centers now increasingly deploy GPU-accelerated compute nodes, custom ASICs, and purpose-built AI accelerators interconnected by ultra-low-latency, high-bandwidth fabrics.

The growth in data center sizes, driven by ML/AI's computational demands, poses challenges such as congestion management in network traffic in data centers. Congestion control (CC) algorithms can be used to manage congestion. A CC algorithm will react and converge to an appropriate rate in case of a congestion scenario. In the event that the congestion scenario is ended by one or more of the participants in the congestion scenario, the other flows need to recover their rate as fast as possible because a slow recovery may cause higher tail latency. Since CC algorithms use negative congestion indications, such as round-trip time (RTT) and explicit congestion notification (ECN), there is a slow recovery in these scenarios since the CC algorithm increases the rate only when there are no indications. But “no indications” may indicate that the rate is okay, not necessarily that the rate is low. Therefore, the CC algorithm cannot have fast increases in these scenarios.

### BRIEF DESCRIPTION OF DRAWINGS

Various embodiments in accordance with the present disclosure will be described with reference to the drawings, in which:

FIG. 1 is a block diagram of a network device having fast-recovery congestion control logic according to at least one embodiment.

FIG. 2 is a block diagram of fast-recovery congestion control between multiple sender NICs sending packets to a receiver NIC via a switch according to at least one embodiment.

FIG. 3A is a graph illustrating a fast recovery using positive congestion indications according to at least one embodiment.

FIG. 3B is a graph illustrating a slow recovery using negative congestion indications according to at least one embodiment.

FIG. 4 is a block diagram of a communication system with a sender network device having a fast-recovery congestion control logic and a receiver network device according to at least one embodiment.

FIG. 5 is a block diagram of a long-short congestion scenario between seven sender nodes and a receiver node via a switch according to at least one embodiment.

FIG. 6A illustrates an aspect of the subject matter in accordance with one embodiment.

FIG. 6B illustrates an aspect of the subject matter in accordance with one embodiment.

FIG. 7A illustrates an aspect of the subject matter in accordance with one embodiment.

FIG. 7B illustrates an aspect of the subject matter in accordance with one embodiment.

FIG. 8 is a block diagram of a data center with a node cluster having multiple sender NICs and a receiver NIC in a congestion scenario according to at least one embodiment.

FIG. 9 is a graph illustrating a bandwidth of a long burst using a positive congestion indication and a bandwidth of a long burst using a negative congestion indication according to at least one embodiment.

FIG. 10 is a graph illustrating a bandwidth of a long burst using a positive congestion indication and a bandwidth of a long burst using a negative congestion indication according to at least one embodiment.

FIG. 11 is a flow diagram of a method for adjusting transmission rate based on positive congestion indications according to at least one embodiment.

FIG. 12A illustrates an example communication system with a controller with fast-recovery congestion control logic according to at least one embodiment.

FIG. 12B illustrates a block diagram of an example communication system employing a fast-recovery congestion control logic in a transmitter and a receiver according to at least one embodiment.

FIG. 13 illustrates an example computer system, including fast-recovery congestion control logic in accordance with at least some embodiments.

FIG. 14 is a block diagram of a computing system having two processing devices coupled to each other and multiple networks according to at least one embodiment.

FIG. 15 is a block diagram of a computing system having a central processing unit (CPU) and a graphics processing unit (GPU) in a single integrated circuit according to at least one embodiment.

FIG. 16 is a block diagram of a computing system having tensor core graphics processing units (GPUs) according to at least one embodiment.

### DETAILED DESCRIPTION

Technologies for fast-recovery congestion control are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, in the event that the congestion scenario is ended by one or more of the participants in the congestion scenario, the other flows need to recover their rate as fast as possible because a slow recovery may cause higher tail latency. That is, all of the participants in the congestion scenario tend to finish first except one. The recovery of this last flow will determine the collective completion time. Since CC algorithms use “negative congestion indications,” such as RTT and ECN, there is a slow recovery in these scenarios since the CC algorithm increases the rate only when there are no indications. But “no indications” may indicate that the rate is okay, not necessarily that the rate is low. Therefore, the CC algorithm cannot have fast increases in these scenarios.

Aspects and embodiments of the present disclosure address these problems and others by providing a CC algorithm that uses positive indications received from a receiver network device (receiver NIC), instead of negative indications. One known positive congestion indication is port utilization at a switch. The collection and sharing of this information uses complicated switch-NIC protocols and needs a lot of end-to-end tuning. Aspects and embodiments of the present disclosure provide collection and sharing of port utilization at a receiver NIC (also referred to herein as receiver network device). Moving the port utilization to the receiver NIC (instead of the switch) gives a positive indication that is easy to report back to the sender NIC efficiently. In this case, the sender NIC can ramp up the rate very fast. The tradeoff is that the CC algorithm cannot react to bottlenecks in the switch itself, but the end-node congestion is more severe most of the time and recovery capabilities at the end-node is needed more than at the switch.

Aspects and embodiments of the present disclosure can configure the receiver NIC to collect telemetry data constantly or periodically, such as port utilization, PCIe counters (PCIe congestion metrics), buffer utilization, byte counters, etc., and send the telemetry data in real time explicitly or by sending raw data with timestamps (e.g., RX byte counts). The sender NIC can use the receiver NIC's telemetry data to identify underutilization of a port which will happen when a congestion scenario is finished. In this case, the sender NIC can ramp up the rate very fast. Compared to conventional CC algorithms that use negative congestion indications, such as RTT and ECN, aspects and embodiments of the present disclosure can improve the speed over recovery after the congestion scenario has ended.

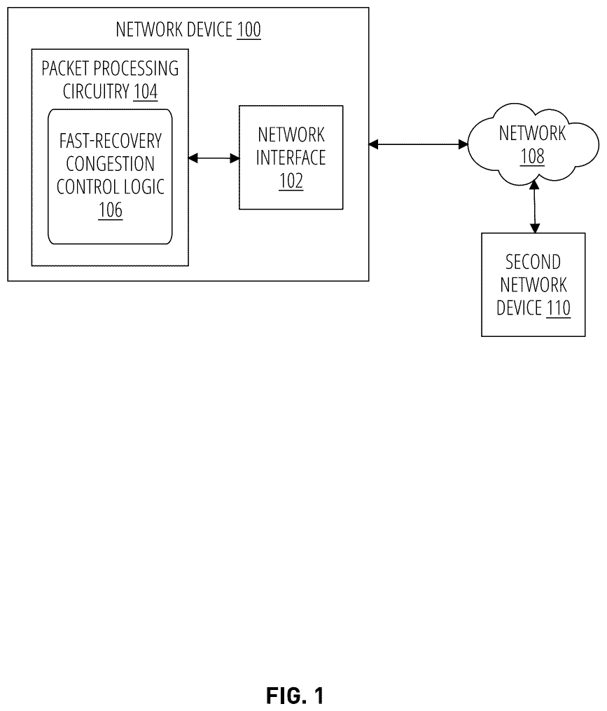

FIG. 1 is a block diagram of a network device 100 having fast-recovery congestion control logic 106 according to at least one embodiment. The network device 100 includes a network interface 102 and packet processing circuitry 104. The network device 100 can be a network adapter, a network interface controller (NIC) (also referred to as network interface cards), a host channel adapter (HCA), or network circuitry implementing NIC or HCA functionality. The network device 100 is communicatively coupled to a network 108. The network 108 can include one or more switches or devices that span over small or large physical distances or cables. The network interface 102 can include circuits to facilitate sending and receiving packets to and from the network 108. The packet processing circuitry 104 is coupled to the network interface 102. The packet processing circuitry 104 can facilitate the processing of outgoing packets being sent by the network interface 102 and incoming packets being received by the network interface 102.

In at least one embodiment, the network interface 102 can be controlled to send first packets of a flow of packets at a first transmission rate over the network 108 to the second network device 110 via a switch. It should be noted that the switch described herein can be one or more switches between the network device 100 and the second network device 110. The packet processing circuitry 104 can receive telemetry data collected by the second network device 110, and determine, using the telemetry data, a positive congestion indication of the flow of packets. In at least one embodiment, the telemetry data is collected by software executing on the second network device 110. In at least one embodiment, the telemetry data is collected by hardware of the second network device 110. In at least one embodiment, the positive congestion indication is a receive (RX) port utilization metric of an RX port at the second network device 110. In at least one embodiment, the telemetry data includes a RX port utilization metric of an RX port at the second network device 110. In at least one embodiment, the telemetry data includes a RX byte count, a timestamp, and a link speed associated with a RX port at the second network device 110, and the packet processing circuitry 104 can determine an RX port utilization metric of the RX port using the RX byte count, the timestamp, and the link speed. It should be noted that the link speed can be a fixed value, but can vary between NICs. That is, the link speed may not be the same for all NICs in the cluster or across clusters. By including the link speed, the packet processing circuitry 104 can determine RX port utilization using the rate of change of the RX byte count divided by the link speed. In at least one embodiment, the packet processing circuitry 104 can receive multiple samples and determine a delta between the RX byte count values, the delta between the timestamps to determine a rate. The rate can be divided by the link speed to obtain the RX port utilization metric. The packet processing circuitry 104 can adjust, using the positive congestion indication, the first transmission rate to a second transmission rate. In some cases, the second transmission rate is lower than the first transmission rate. In other cases, the second transmission rate is higher than the first transmission rate. The packet processing circuitry 104 can cause the network interface 102 to send second packets of the flow of packets at the second transmission rate over the network 108 to the second network device 110 via the switch.

In at least one embodiment, the fast-recovery congestion control logic 106 can receive telemetry data collected by the second network device 110, and determine, using the telemetry data, a positive congestion indication of the flow of packets. Similarly, as described above, the positive congestion indication can be an RX port utilization metric included in the telemetry data. Alternatively, the telemetry data can include an RX byte count, a timestamp, and a link speed associated with a RX port at the second network device 110, and the fast-recovery congestion control logic 106 can determine an RX port utilization metric of the RX port using the RX byte count, the timestamp, and the link speed. The fast-recovery congestion control logic 106 can adjust, using the positive congestion indication, the first transmission rate to a second transmission rate. In some cases, the second transmission rate is lower than the first transmission rate. In other cases, the second transmission rate is higher than the first transmission rate. The fast-recovery congestion control logic 106 can cause the network interface 102 to send second packets of the flow of packets at the second transmission rate over the network 108 to the second network device 110 via the switch.

In at least one embodiment, the packet processing circuitry 104 (or fast-recovery congestion control logic 106) can receive the telemetry data in a response to a probe packet previously sent by the network device 100. The response can be an acknowledgement (ACK) sent by the second network device 110 in response to the probe packet.

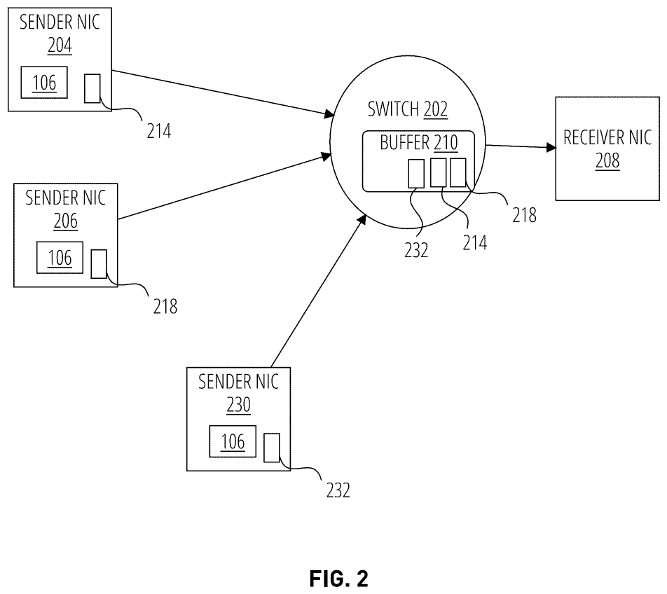

FIG. 2 is a block diagram of fast-recovery congestion control between multiple sender NICs 204, 206, 230, sending packets to a receiver NIC 208 via a switch 202 according to at least one embodiment. In this embodiment, the CC algorithm used in the sender NICs is based on positive congestion indications received from the receiver NIC 208 and evaluating congestion state accordingly. Although the following description refers to sender and receiver NICs, in other embodiments, other network devices and other delay measurements can be used.

As described above, a CC algorithm should react and converge to an appropriate rate in case of a congestion scenario and, in the event that the congestion scenario is ended by one or more of the participants in the congestion scenario, the other flows need to recover their rate as fast as possible because a slow recovery may cause higher tail latency. Traditional CC algorithms use negative congestion indications, such as RTT and ECN, there is slow recovery in these scenarios since the CC algorithm increases the rate only when there are no indications. But “no indications” may indicate that the rate is okay, not necessarily that the rate is low. Therefore, the traditional CC algorithms cannot have fast increases in these scenarios.

In contrast, the fast-recovery congestion control logic 106 in the sender NICs can react and converge to an appropriate rate in congestion scenarios, and recovery their rate as fast as possible when the congestion scenario is ended by one or more participants using positive congestion indications, instead of negative congestion indications. In particular, the fast-recovery congestion control logic 106 can receive telemetry data collected by the second network device, the telemetry data comprises a positive congestion indication or the fast-recovery congestion control logic 106 can determine the positive congestion indication from the telemetry data. The fast-recovery congestion control logic 106 can adjust the transmission rate accordingly using the positive congestion indication. This results in fast recovery when a congestion scenario is ended by one or more participants. The fast-recovery congestion control logic 106 can also adjust in response to changes to the congestion scenario.

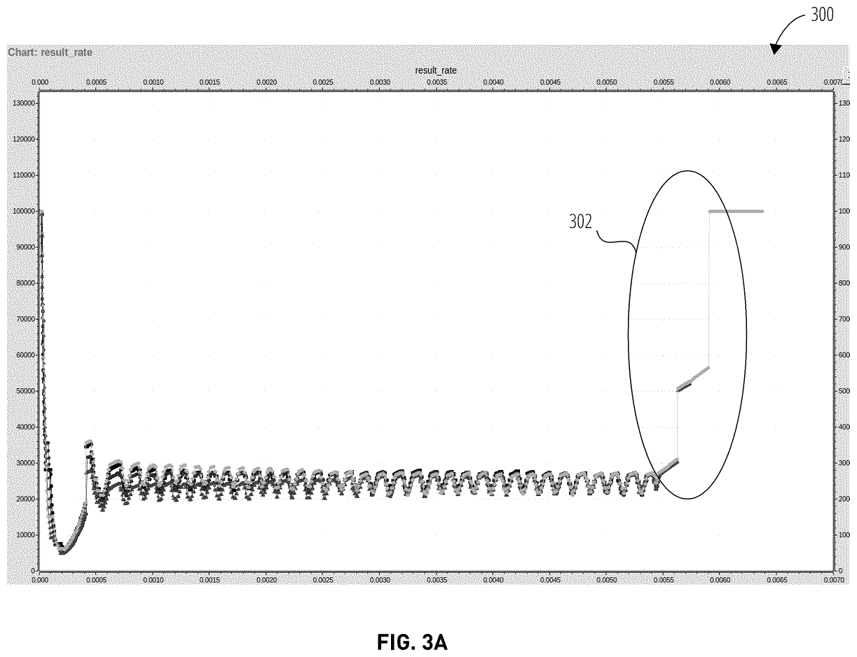

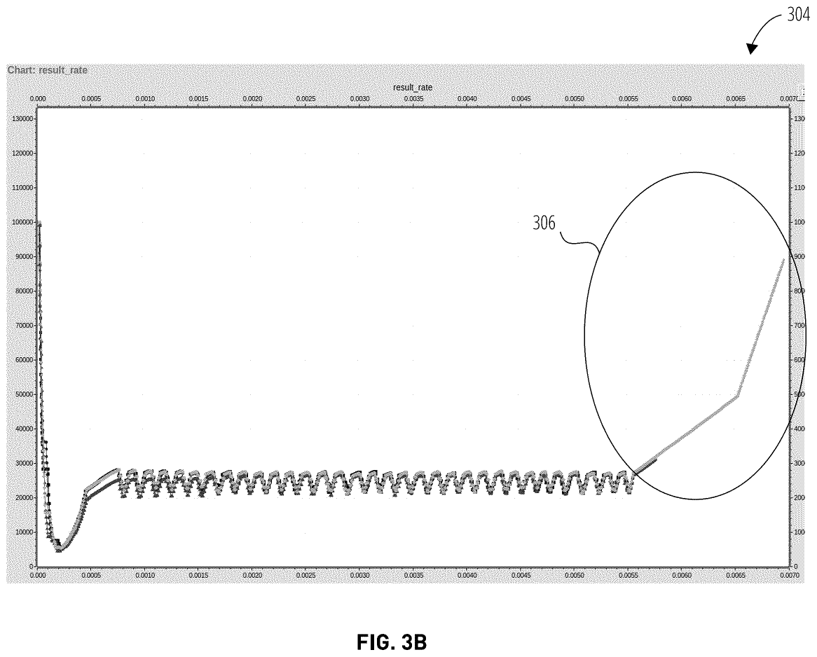

In at least one embodiment, the receiver NIC 208 can constantly (or periodically as programmed) to collect and send telemetry data to the corresponding sender NIC. The telemetry data can include port utilization, PCIe counters (PCIe congestion metrics), buffer utilization, byte counters, etc. The receiver NIC 208 can send the telemetry data with at least one positive congestion indication in real time explicitly or by sending raw data with timestamps, such as samples with RX byte count, timestamp, and link speed so that the fast-recovery congestion control logic 106 can determine the positive congestion indication. The sender NIC can use the receiver NIC's telemetry data to identify underutilization of a port which will happen when a congestion scenario is finished. In this case, the fast-recovery congestion control logic 106 can ramp up the rate very fast. Compared to conventional CC algorithms that use negative congestion indications, such as RTT and ECN, the fast-recovery congestion control logic 106 can improve the speed over recovery after the congestion scenario has ended. An example of fast recovery using positive congestion indications is illustrated in FIG. 3A, as compared to recovery using negative congestion indications in FIG. 3B.

FIG. 3A is a graph 300 illustrating a fast recovery 302 using positive congestion indications according to at least one embodiment. Graph 300 shows a congestion scenario. At the end of the congestion scenario, the rate is increased back to the original link speed (also referred to as line rate). The rate has increased incrementally as participants drop from the congestion scenario. For example, there can be four original participants in the congestion scenario. The fast recovery 302 starts when two participants drop from the congestion scenario, and then later, another participant drops from the congestion scenario, leaving one participant. In at least one embodiment, the receiver NIC (also referred to as notification point (NP) can send the port RX byte count (also referred to as RX byte counter) in response to probes by the sender NIC (also referred as the reaction point (RP)). The fast-recovery congestion control logic 106 (on the sender NIC) can calculate the RX rate on the receiver and recover fast when there is underutilization. The RX port utilization can be determined by determining the rate of change of the RX byte count divided by the link speed. Since positive congestion indications are used, the rate can be increased immediately instead of waiting as done with negative congestion indications, as illustrated in FIG. 3B.

FIG. 3B is a graph 304 illustrating a slow recovery 306 using negative congestion indications according to at least one embodiment. Graph 304 shows the same congestion scenario as graph 300. At the end of the congestion scenario, the rate increased incrementally, yet slower than in the fast recovery 302.

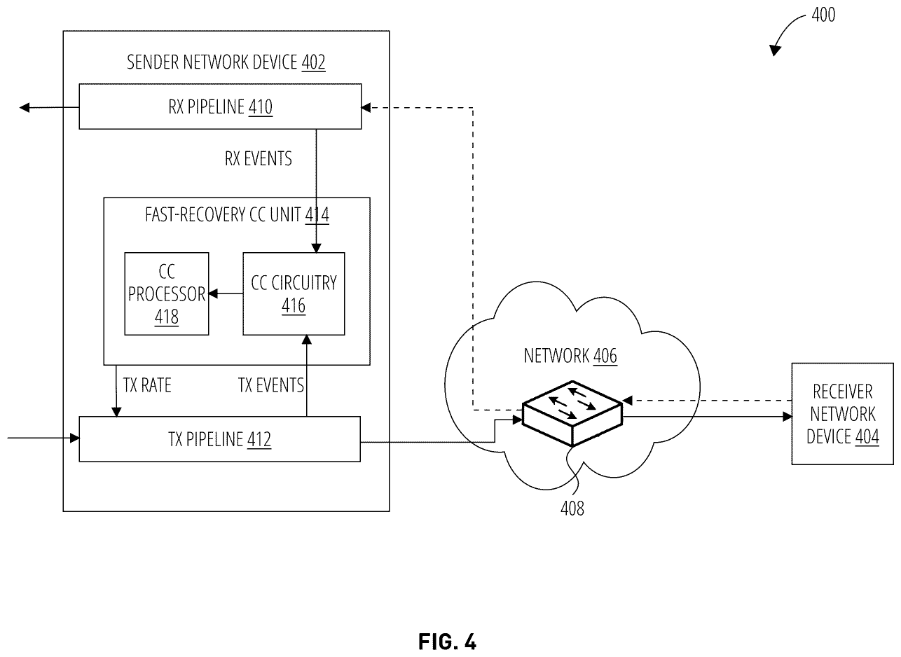

FIG. 4 is a block diagram of a communication system 400 with a sender network device 402 having a fast-recovery CC unit 414 and a receiver network device 404 according to at least one embodiment. The fast-recovery CC unit 414 can implement a fast-recovery CC algorithm. In general, fast-recovery CC algorithms change the transmission rate (also referred to as transmit rate or TX rate) of packets from a source that transmits packets (e.g., a network adapter in a source node), in response to positive congestion notifications that the source receives. In some cases, congestion notifications can be added to a packet stream (either as a separate packet, or as an additional information on an existing packet). When the packets reach their destination (e.g., a network adapter in a destination node), the destination sends the congestion notifications back to the source, which may decrease the transmit rate in response to the notification (or increase the rate if no congestion notifications are received). The CC algorithms are typically flow-oriented, and the rate of each flow of packets is independently controlled, in response to positive congestion notifications pertaining to packets of the same flow.

In at least one embodiment, the fast-recovery CC algorithm is implemented as instructions executed by a processing device of the sender network device 402. In at least one embodiment, the fast-recovery CC algorithm is implemented using CC circuitry 416 and CC processor 418 of the fast-recovery CC unit 414, coupled between a receive (RX) pipeline 410 and a transmit (TX) pipeline 412, as illustrated in FIG. 4. The CC processor 418 can be a dedicated congestion control programmable processor (“CC processor 318”, also referred to as “processor”) that is tightly coupled to the communication ports. The CC processor 418 can throttle (decrease or increase) the TX rate of packets, responsive to the network's traffic load. In embodiments, the CC circuitry 416 is configured to send, return and receive telemetry data, which is used for setting the TX rate, especially at the end of congestion scenarios. As described herein, the fast-recovery CC unit 414 can receive telemetry data, such as RX byte count, timestamp, and link speed, and determine a positive congestion indication, such as RX port utilization to quickly recover the rate at the end of congestion scenarios. In at least one embodiment, the CC circuitry 416 is coupled to the network interface and controls transmission rates of different flows of packets. The CC processor 418 is coupled to the CC circuitry 416 and is configured to execute instructions to receive the telemetry data, determine the positive congestion indication, and cause the CC circuitry 416 to adjust the first transmission rate to the second transmission rate for the flow of packets. The CC circuitry 416 can cause the network interface to send the second packets of the flow of packets at the second transmission rate over the network to the second network device via the switch.

The sender network device 402 (e.g., sender NIC) typically include one or more ingress ports, that receive packets from a network 406 and send the packets to an input queue; and one or more egress ports, that receive packets from an output queue and send the packets to the network 406. In the description herein, we will refer to the aggregation of the ingress ports and the input queue as RX pipeline 410 (or RX pipe), and to the aggregation of the output queue and the egress ports as TX pipeline 412 (or TX pipe).

In at least one embodiment, the CC circuitry 416 includes an events queue, which is configured to receive TX and RX notifications pertaining to sending and receiving packets, respectively, and to send the events notifications to the CC processor 418. The CC circuitry 416 typically receives TX notifications for each predefined burst of sent packets, and RX notifications for the following received packets: positive and negative acknowledgment (ACK and NACK) packets; congestion notification packets (packets that are sent back by a peer network adapter in response to the sent packets); and returned RTT measurement packets. The RX notifications can include the telemetry data or the positive congestion indications as described herein.

In some embodiments, to avoid congestions in the events queue, the CC circuitry 416 is configured to discard (drop) some of the events, responsive to the occupancy of the queue (this congestion is not to be confused with congestion in the network).

In some of the example embodiments below, references are made to Remote Direct Memory Access (RDMA) over Converged Ethernet (RoCE); however, the techniques disclosed herein are not limited to RoCE, and may be used in any suitable network configurations.

According to some embodiments, the event types that are stored in the event queue comprise:
1. TX—sending of a burst of packets;
2. CNP—receiving of a Congestion Notification Packet (CNP);
3. NACK—receiving of NACK;
4. ACK—receiving of ACK;
5. RTT—receiving a response packet to a Round-Trip-Delay (RTT) measurement packet; and
6. Host injected events.

In some embodiments, events are represented in the events queue by entries that include an event-type field, a timestamp field, a serial-number field, a flow-identification field, a field representing the number of sent bytes for a Tx event, and fields for additional RTT-receipt-event time stamps.

In some embodiments, events queue includes, in addition to events that are generated by the Tx and Rx pipes, events that the Firmware generates, which may be defined by a user of the NIC and provide algorithm flexibility.

In some embodiments, the CC circuitry 416 includes an arbiter (e.g., round robin), which selects an event to be processed from the events queue, or a firmware event. In some embodiments, the number of event types may be larger than the number of event types that the CC circuitry 416 can handle, and a mapping may be employed, which maps more than one event type to the same “event class”.

In embodiments, the CC algorithms that the CC processor 418 runs includes a plurality of concurrent processes, wherein each process controls congestion in a single flow of packets. Each process is configured to receive events pertaining to the corresponding flow, update the rate (and, possibly, request RTT measurements), and then pause until the next event is received. To allow execution by a limited number of processors, each process is assigned a context in memory; a process may be paused by storing the context and resumed by reading the stored context (as the number of possible contexts may be large, contexts pertaining to flows that are not active are typically stored in a slower memory, and read by the processor when needed).

According to some embodiments, the CC processor 418 includes a plurality of independent processors, and events that the CC circuitry 416 sends to the CC processor 418 for processing are allocated to processors that are not busy. A processor that is assigned to handle an event reads the corresponding context, and then runs the process, possibly changing the transmit rate for the flow and/or requesting RTT measurements, and, lastly, stores the updated context, in preparation for the processing of the next event.

In some embodiments, reliable measurement of packet round-trip delay (RTT) is an important parameter for the CC algorithm. RTT measurement is typically done by calculating the time difference from the sending of a packet to the receiving a of corresponding ACK; however, such measurement technique is not accurate, because the ACK is initiated by the processor, and the RTT measurement will include the time it takes for the software to respond.

As described herein, some embodiments support RTT measurement packets, which are sent from a Sender Network Interface Controller (NIC) to a Receiver NIC, which returns the packet to the Sender NIC. The sender NIC adds a first timestamp to the sent packet; the receiver NIC adds a second timestamp to the packet when the packet is received, routes back the packet to the Sender-NIC, and adds a third timestamp when the packet is sent back. The Sender NIC can then, by observing the three time stamps (and the time in which the return packet arrives), accurately calculate the RTT, breaking it to segments, including time from sender-NIC to receiver-NIC, time within the receiver-NIC, time (of the return packet) from receiver-NIC to sender-NIC.

In at least one embodiment, the communication system 400 has an RoCE architecture with congestion mitigation. A sender network device 402 (e.g., a transmitting NIC) transmits packets over a network 406 to a receiver network device 404 (e.g., receiving NIC). (It should be noted that both the transmitting NIC and the receiving NICs are configured to both transmit and receive packets; the terms “transmitting” and “receiving” hereinabove refer to the direction in which congestion is mitigated.)

As described above, the sender network device 402 includes a TX pipeline 412, which queues and arbitrates packets that the sender network device 402 transmits and sends the packets to network 406. The network 406 include, according to the example embodiment illustrated in FIG. 4, a switch 408, which, when congested, marks packets the transmitting NIC sends with an Explicit Congestion indication (ECN). The receiver network device 404 sends return packets back to the sender network device 402, including packets that are used for congestion control (designated by dashed lines in FIG. 4), such as CNP packets, ACK/NACK packets, and RTT measurement packets. When the receiver network device 404 receives a packet with ECN indication, the receiver network device 404 sends a CNP packet back to the sender network device 402. In addition to, or in place of the RTT measurements, the positive congestion indications can be used for fast-recovery congestion control as described herein.

As illustrated, the sender network device 402 includes an RX pipeline 410, which receives incoming packets from the network 406, and a fast-recovery CC unit 414.

The fast-recovery CC unit 414 is configured to execute congestion control algorithms and mitigate congestion in the RoCE transmit path, including determining positive congestion indications to adjust the transmission rate accordingly. The fast-recovery CC unit 414 includes the CC processor 418, which is configured to run congestion control algorithms, and a CC circuitry 416, which is configured to send congestion events to the CC processor 418.

In at least one embodiment, the CC circuitry 416 receives Tx events when TX pipeline 412 sends bursts of packets, and Rx events when RX pipeline 410 receives congestion control packets. (The received congestion control packets may include, for example, ACK and NACK that are received in response to transmitted packets, CNP packets that the receiving NIC generates in response to receiving ECN-marked packets, and RTT measurement packets.) In addition to, or in place of the RTT measurements, the positive congestion indications can be used for fast-recovery congestion control as described herein.

The CC circuitry 416 queues the events and sends at least some of the events to the CC processor 418 over a hardware-implemented direct point-to-point interface. In the present context, the term “direct point-to-point interface” means an interface that does not involve communication over a bus, an interrupt or any other operating system invocation. The CC processor 418 processes the events and runs congestion control algorithms to calculate the required transmission rate for further packets, and then informs the rates to TX pipeline 412 and, optionally, requests that the TX pipeline 412 send an RTT measurement packet.

In some embodiments, the CC processor 418 runs the congestion control algorithms separately for each flow of packets, and the transmission rate is determined separately for each flow.

In at least one embodiment, communication between the CC circuitry 416 and CC processor 418 does not involve operating system calls—the CC processor 418 signals that it is ready to process events (e.g., by asserting a dedicated signal) and then reads the event on an input bus that the CC circuitry 416 drives.

Thus, according to the example embodiment of FIG. 4, congestion events are queued in by dedicated circuitry, and submitted to a dedicated processor that runs congestion control algorithms, modifying the transmit rate accordingly. The overhead associated with running the algorithms is small, and flexibility to changing congestion control algorithms is preserved.

As would be appreciated, the configuration of RoCE architecture is an example configuration that is depicted purely for the sake of conceptual clarity. Other suitable configurations may be used in alternative embodiments. For example, instead of (or in addition to) RoCE, the architecture may be TCP and/or converged Non-Volatile-Memory (NVM) storage (e.g., hyper-converged NVM-f). Congestion events that CC circuitry 416 receives may be pre-sorted by additional hardware or software; the rate at which the TX pipeline 412 sends the packets may be jointly controlled by CC processor 418 and by other algorithms of sender network device 402.

In at least one embodiment, the sender network device 402 is a first network adapter including the RX pipeline 410, the TX pipeline 412, the CC circuitry 416, and the CC processor 418. The RX pipeline 410 is configured to receive packets from the network 406 and process the received packets. The network 406 includes at least one switch 408 between the first network adapter and the receiver network device 404 (i.e., a second network adapter). The TX pipeline 412 is configured to transmit packets to the network 406. The CC circuitry 416 is coupled to the RX pipeline 410 and the TX pipeline 412. The CC processor 418 is coupled to the CC circuitry 416. The CC processor 418 is configured to perform various operations, including: receiving telemetry data associated with a RX port at the second sender network device 402 (i.e., second network adapter); determining, using the telemetry data, a port utilization of the RX port; adjusting, using the port utilization, a first transmission rate of a flow of packets to the sender network device 402 to a second transmission rate; and causing the TX pipeline 412 to transmit packets, directed to the sender network device 402, at the second transmission rate. In at least one embodiment, the second transmission rate is higher than the first transmission rate. In at least one embodiment, the second transmission rate is lower than the first transmission rate.

In a further embodiment, the telemetry data include a RX port utilization metric of the RX port, and the CC processor 418 can determine the port utilization using the RX port utilization metric. In at least one embodiment, the telemetry data includes an RX byte count, a timestamp, and a link speed associated with the RX port, and the CC processor 418 can determine the port utilization of the RX port using the RX byte count, the timestamp, and the link speed.

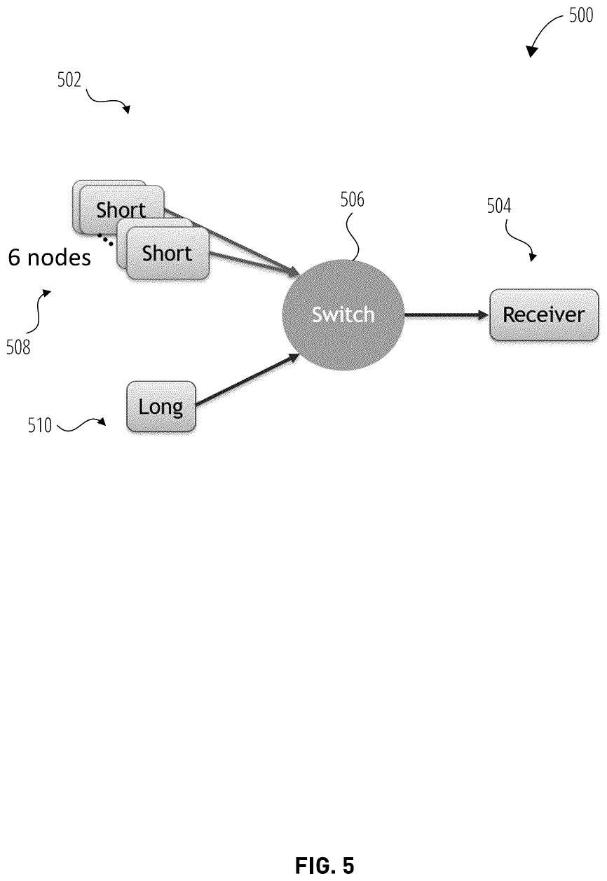

In a further embodiment, the CC processor 418 can receive the telemetry data in a response to a probe packet previously sent by the sender network device 402. A comparative example of using the positive congestion indication versus negative congestion indications is described and illustrated below with respect to FIG. 5.

FIG. 5 is a block diagram of a long-short congestion scenario 500 between seven sender nodes 502 and a receiver node 504 via a switch 506 according to at least one embodiment. The seven sender nodes 502 can include six short-burst nodes 508 and one long-burst node 510.

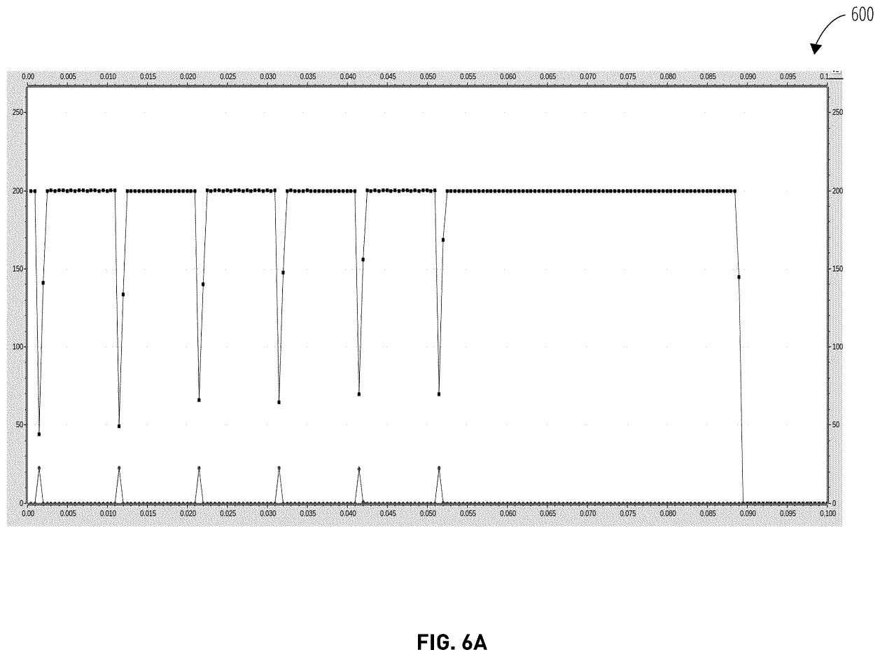

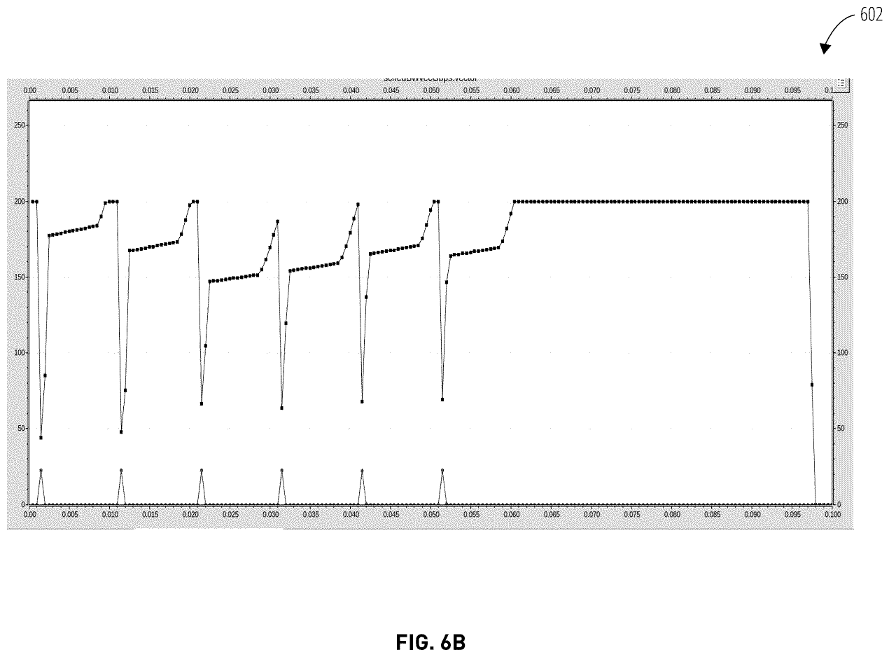

The following examples as illustrated and described below with respect to FIG. 6A to FIG. 9, shows faster recovery of congestion scenarios of the eight NICs using positive congestion indications, instead of negative congestion indications.

FIG. 6A is a graph 600 showing rate adjustments using a positive congestion indication according to at least one embodiment. In this example, there are the eight NICs, seven sender NICs and one receiver NIC with six iterations, as illustrated in FIG. 5. The six short-burst nodes 508 can each have a short flow with one QP with a burst size of 8 MB split, and the long-burst node 510 can have a long flow with one QP and a long flow size of 2 GB. There can be 10 ms between bursts. In this example, the receiver node 504 reports telemetry data that allows the fast-recovery congestion control logic 106 to determine the positive congestion indication (e.g., RX port utilization metric). As illustrated in graph 600, the recovery to line rate is fast between each burst and the overall time to complete the bursts is less than shown in graph 602 of FIG. 6B.

FIG. 6B is a graph 602 showing rate adjustments using a negative congestion indications according to at least one embodiment. Similar to FIG. 6A, the configuration includes the same eight NICs and short and long flows. Instead of the positive congestion indication, the CC algorithm uses a negative congestion indication (such as RTT). As illustrated in graph 602, the recovery to line rate is slow between each burst and the overall time to complete the bursts is greater than shown in graph 600 of FIG. 6A.

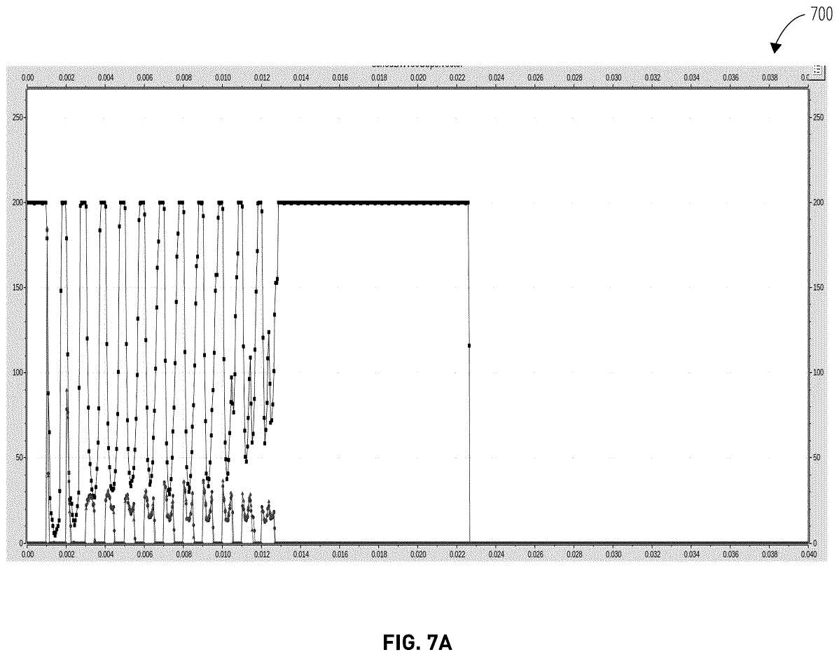

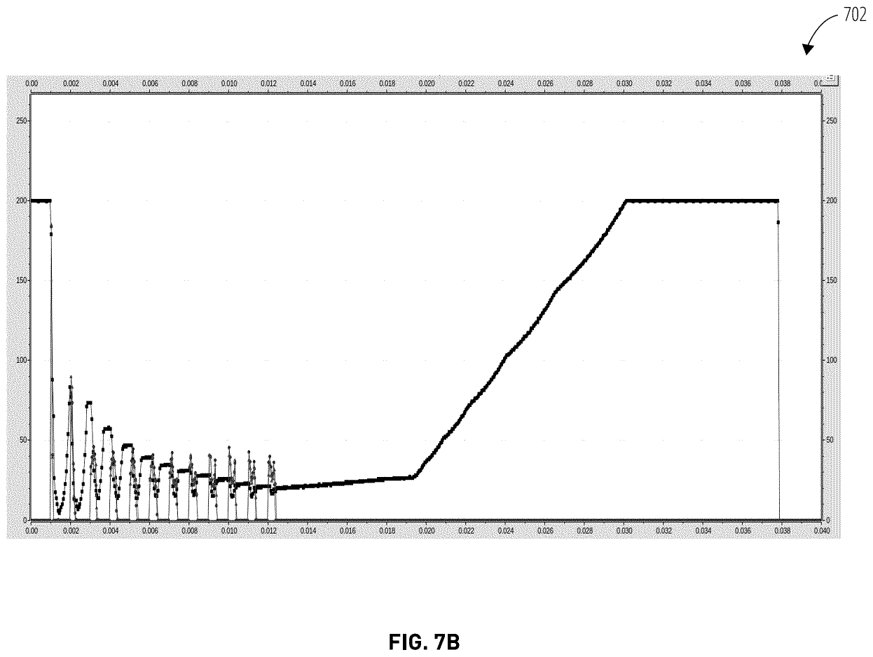

FIG. 7A is a graph 700 showing rate adjustments using a positive congestion indication according to at least one embodiment. In this example, there are the eight NICs, seven sender NICs and one receiver NIC with six iterations, as illustrated in FIG. 5. The six short-burst nodes 508 can each have a short flow with one QP with a burst size of 8 MB split, and the long-burst node 510 can have a long flow with one QP and a long flow size of 400 MB. There can be 1 ms between bursts. In this example, the receiver node 504 reports telemetry data that allows the fast-recovery congestion control logic 106 to determine the positive congestion indication (e.g., RX port utilization metric). As illustrated in graph 700, the recovery to line rate is fast between each burst and the overall time to complete the bursts is less than shown in graph 702 of FIG. 7B.

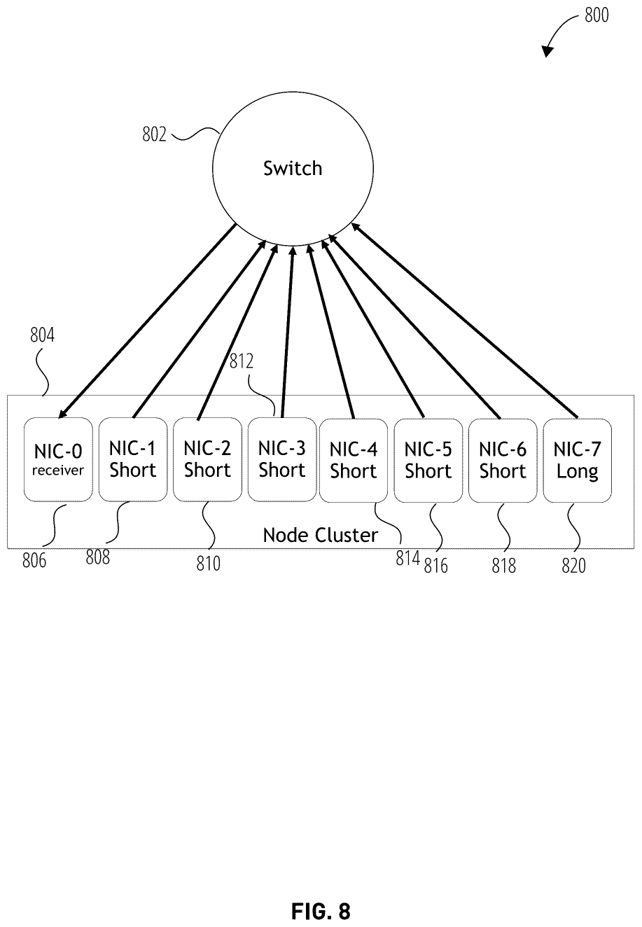

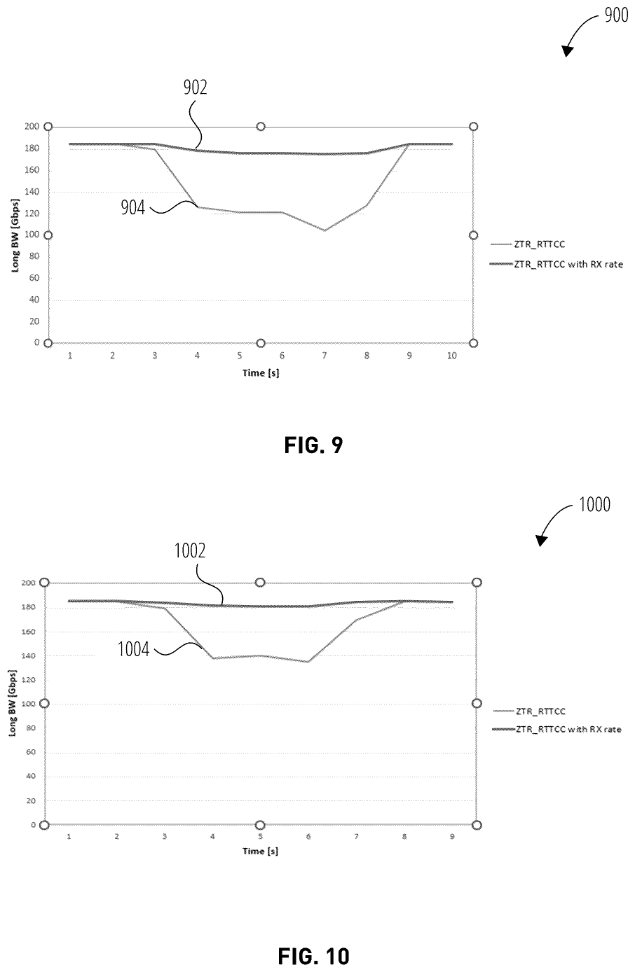

FIG. 7B is a graph 702 showing rate adjustments using a negative congestion indications according to at least one embodiment. Similar to FIG. 7A, the configuration includes the same eight NICs and short and long flows. Instead of the positive congestion indication, the CC algorithm uses a negative congestion indication (such as RTT). As illustrated in graph 702, the recovery to line rate is slow between each burst and the overall time to complete the bursts is greater than shown in graph 700 of FIG. 7A. It should be noted that FIG. 6A, FIG. 6B, FIG. 7A, and FIG. 7B show every iteration in the simulations. In a real system, it is hard to measure in such granularity. Therefore, multiple iterations (e.g., 3000) can be run on a real system, such as illustrated in FIG. 8, and the rate over time (e.g., every 1 second) can be measured, as illustrated in FIG. 9 and FIG. 10.

FIG. 8 is a block diagram of a data center 800 with a node cluster 804 having multiple sender NICs and a receiver NIC in a congestion scenario according to at least one embodiment. The node cluster 804 includes a receiver NIC 806 and seven sender NICs 808 to 820. The eight NICs can be in a long-short congestion scenario where this is a many-to-one bursts application on the eight NICs where NIC-0 is the receiver NIC 806, and NICs-1-7 are the sender NICs 808 to 820. In this long-short congestion scenario, most of the NICs (i.e., sender NIC 808 to 818) have short bursts (also referred to as short flows) and one NIC (i.e., sender NIC 820) has a long burst (also referred to as a long flow) . Although these eight NICs are illustrated as part of the same node cluster 804, in other embodiments, the NICs do not have to be part of the same node cluster, as illustrated in FIG. 5.

FIG. 9 is a graph 900 illustrating a bandwidth 902 of a long burst using a positive congestion indication and a bandwidth 904 of a long burst using a negative congestion indication according to at least one embodiment. The graph shows the bandwidth over 3000 iterations with a burst size of 8 Mb, 1 ms time between bursts, and a long flow with one QP.

FIG. 10 is a graph 1000 illustrating a bandwidth 1002 of a long burst using a positive congestion indication and a bandwidth 1004 of a long burst using a negative congestion indication according to at least one embodiment. The graph shows the bandwidth over 3000 iterations with a burst size of 8 Mb, 10 ms time between bursts, and a long flow with one QP.

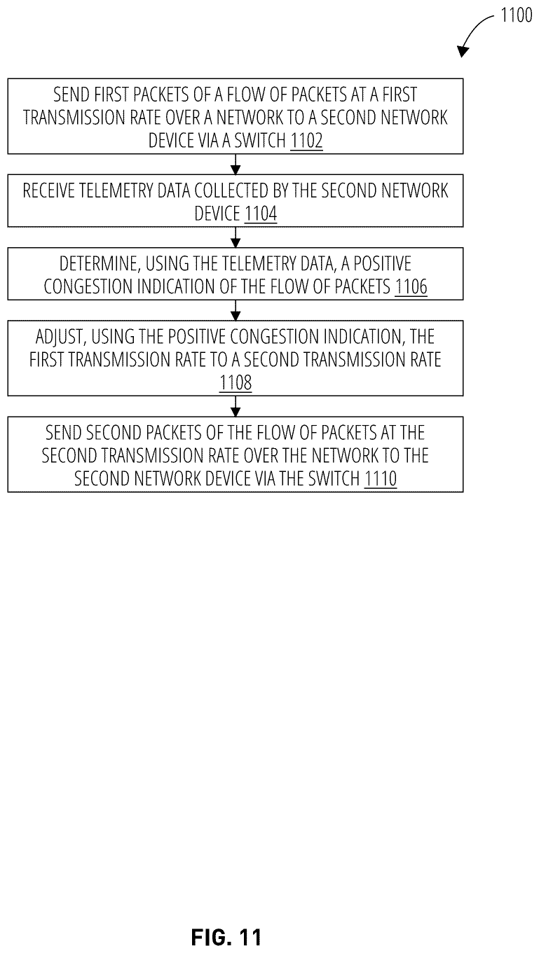

FIG. 11 is a flow diagram of a method 1100 for adjusting transmission rate based on positive congestion indications according to at least one embodiment. The method 1100 can be performed by processing logic comprising hardware, software, firmware, or any combination thereof. In at least one embodiment, the method 1100 is performed by any one of network device 100 of FIG. 1, sender NIC 204, sender NIC 206, sender NIC 230, or receiver NIC 208 of FIG. 2, or sender network device 402 or receiver network device 404 of FIG. 4, receiver NIC 806, sender NIC 808 to sender NIC 820 of FIG. 8, seven sender nodes 502 or receiver node 504 of FIG. 5. In other embodiments, the method 1100 can be performed by other devices as described herein.

Referring to FIG. 11, the method 1100 begins with the processing logic sending first packets of a flow of packets at a first transmission rate over a network to a second network device via a switch (block 1102). At block 1104, the processing logic receives telemetry data collected by the second network device. At block 1106, the processing logic determines, using the telemetry data, a positive congestion indication of the flow of packets. At block 1108, the processing logic adjusts, using the positive congestion indication, the first transmission rate to a second transmission rate. At block 1110, the processing logic sends second packets of the flow of packets at the second transmission rate over the network to the second network device via the switch.

In at least one embodiment, the second transmission rate is higher than the first transmission rate. In at least one embodiment, the second transmission rate is lower than the first transmission rate.

In at least one embodiment, the positive congestion indication is a RX port utilization metric of an RX port at the second network device. In at least one embodiment, the telemetry data includes an RX port utilization metric of an RX port at the second network device.

In at least one embodiment, at block 1104, the processing logic receives the telemetry data in a response to a probe packet previously sent by the first network device.

In at least one embodiment, a programmable network device can include a processing unit, memory operatively coupled to the processing unit, and a network interface coupled to the processing unit and a switch. The memory can store instructions that, when executed by the processing unit, cause the programmable network device to perform the various operations described herein, such as the operations of method 1100. In at least one embodiment, the network device is a DPU. In at least one embodiment, the network device can include a Data Path Accelerator.

In at least one embodiment, a first network device (e.g., network adapter, NIC, or the like) can include a network interface to receive first packets over a network from a second network device via a switch, and packet processing circuitry coupled to the network interface. The packet processing circuitry can receive telemetry data from the second network device in connection with receiving the first packets, the telemetry data representing port utilization at the second network device. The packet processing circuitry can adjust, using the telemetry data, a transmission rate from a first transmission rate to a second transmission rate. The packet processing circuitry can send, using the second transmission rate, second packets over the network to the second network device. In a further embodiment, the network interface includes an RX pipeline configured to receive first packets from a network and process the first packets, and a TX pipeline configured to send second packets to the network. The processing unit can include a congestion controller coupled between the RX pipeline and the TX pipeline.

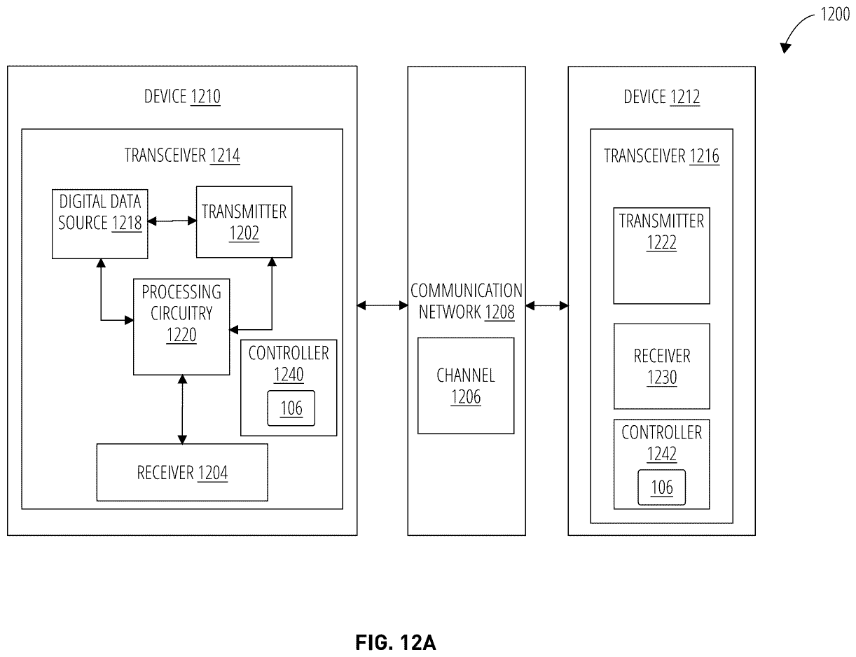

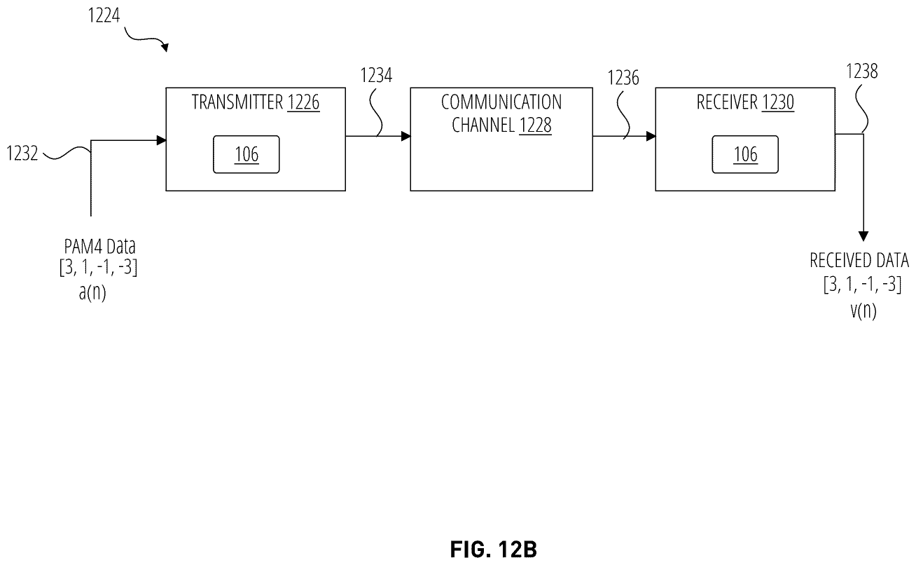

FIG. 12A illustrates an example communication system 1200 with a controller 1240 with fast-recovery congestion control logic 106 according to at least one embodiment. The communication system 1200 includes a device 1210, a communication network 1208 including a communication channel 1206, and a device 1212. In at least one embodiment, the devices 1210 and 1212 are integrated circuits of a Personal Computer (PC), a laptop, a tablet, a smartphone, a server, a collection of servers, or the like. In some embodiments, the devices 1210 and 1212 may correspond to any appropriate type of device that communicates with other devices also connected to a common type of communication network 1208. According to embodiments, the transmitter 1202 and 1222 of devices 1210 or 1212 may correspond to transmitters of a Graphics Processing Unit (GPU), a switch (e.g., a high-speed network switch), a network adapter, a central processing unit (CPU), a data processing unit (DPU), etc.

Examples of the communication network 1208 that may be used to connect the devices 1210 and 1212 include wires, conductive traces, bumps, terminals, optical fibers, or the like. In other embodiments, the communication network 1208 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 1208 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 1208 is a network that enables data transmission between the devices 1210 and 1212 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks.

In at least one embodiment, a system for high-speed network communication includes a processing unit, and a network adapter coupled to the processing unit. The network adapter includes a receive (RX) pipeline, configured to receive packets from a network and process the received packets. The network comprising at least one switch between the first network adapter and a second network adapter. The network adapter includes a transmit (TX) pipeline, configured to transmit packets to the network. The network adapter includes congestion control (CC) circuitry coupled to the RX pipeline and TX pipeline, and a CC processor coupled to the CC circuitry. The CC processor can receive telemetry data associated with a RX port at the second network adapter. The CC processor can determine, using the telemetry data, a port utilization of the RX port. The CC processor can adjust, using the port utilization, a first transmission rate of a flow of packets to the second network adapter to a second transmission rate. The CC processor can cause the TX pipeline to transmit packets, directed to the second network adapter, at the second transmission rate. The processing unit can include a CPU, a GPU, a DPU, a deep learning accelerator, an inference accelerator, or the like.

Other examples for the communication network 1208 can include other chip-to-chip or die-to-die interconnects, such as GRS, LPI (low power interface) or LLI (low latency interface).

The device 1210 includes a transceiver 1214 for sending and receiving signals, for example, data signals. The data signals may be digital or optical signals modulated with data or other suitable signals for carrying data.

The transceiver 1214 may include a digital data source 1218, a transmitter 2402, a receiver 1204, and processing circuitry 1220 that controls the transceiver 1214. The digital data source 1218 may include suitable hardware and/or software for outputting data in a digital format (e.g., in binary code and/or thermometer code). The digital data output by the digital data source 1218 may be retrieved from memory (not illustrated) or generated according to input (e.g., user input). The transceiver 1214 can include the controller 1240 with the fast-recovery congestion control logic 106 as described above with respect to FIG. 1 to FIG. 11.

The transceiver 1214 includes suitable software and/or hardware for receiving digital data from the digital data source 1218 and outputting data signals according to the digital data for transmission over the communication network 1208 to a transceiver 1216 of device 1212.

The receiver 1204 of device 1210 may include suitable hardware and/or software for receiving signals, for example, data signals from the communication network 1208. For example, the receiver 1204 may include components for receiving processing signals to extract the data for storing in a memory. In at least one embodiment, the transceiver 1216 includes a transmitter 1222 and receive 1230. The transceiver 1216 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. The transceiver 1216 can include a controller 1242 with the fast-recovery congestion control logic 106 as described above with respect to FIG. 1 to FIG. 11.

The processing circuitry 1220 may comprise software, hardware, or a combination thereof. For example, the processing circuitry 1220 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 1220 may comprise hardware, such as an Application-Specific Integrated circuit (ASIC). Other non-limiting examples of the processing circuitry 1220 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 1220 may be provided on a Printed Circuit Board (PCB) or collection of PCBs. It should be appreciated that any appropriate type of electrical component or collection of electrical components may be suitable for inclusion in the processing circuitry 1220. The processing circuitry 1220 may send and/or receive signals to and/or from other elements of the transceiver 1214 to control the overall operation of the transceiver 1214.

The transceiver 1214 or selected elements of the transceiver 1214 may take the form of a pluggable card or controller for the device 1210. For example, the transceiver 1214 or selected elements of the transceiver 1214 may be implemented on a network interface card (NIC).

The device 1212 may include a transceiver 1216 for sending and receiving signals, for example, data signals over a channel 1206 of the communication network 1208. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 1214 may be applied to transceiver 1216, and thus, the structure of transceiver 1216 is not described separately.

Although not explicitly shown, it should be appreciated that devices 1210 and 1212 and the transceiver 1214 and transceiver 1216 may include other processing devices, storage devices, and/or communication interfaces generally associated with computing tasks, such as sending and receiving data.

FIG. 12B illustrates a block diagram of an example communication system 1224 employing a fast-recovery congestion control logic 106 in a transmitter 1226 and a receiver 1230 according to at least one embodiment.

In the example shown in FIG. 12B, a PAM level-4 (PAM4) modulation scheme is employed with respect to the transmission of a signal (e.g., digitally encoded data) from a transmitter (TX) transmitter 1226 to a receiver (RX) signal 1238 via a communication channel 1228 (e.g., a transmission medium). In this example, the transmitter 726 receives input data 723 (i.e., the input data at time n is represented as “a(n)”), which is modulated in accordance with a modulation scheme (e.g., PAM4) and sends the signal 1234, a(n), including a set of data symbols (e.g., symbols −3, −1, 1, 3, wherein the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM7, PAM8, PAM16, etc. For example, for an NRZ-based system, the transmitted data symbols consist of symbols-1 and 1, with each symbol value representing a binary bit. This is also known as a PAM level-2 or PAM2 system as there are 2 unique values of transmitted symbols. Typically, a binary bit 0 is encoded as −1, and a binary bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 1228 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 1228 can be over serial links (e.g., a cable, printed circuit boards (PCBs) traces, copper cables, optical fibers, or the like), read channels for data storage (e.g., hard disk, flash solid-state drives (SSDs), high-speed serial links, deep space satellite communication channels, applications, or the like.

As described above, in some communication systems, the transmitter 1226 sends the signal 1234 as a data signal without a transmitter clock used to generate the data signal. The receiver (RX) 1230 receives an incoming signal 1236 over the communication channel 1228. The incoming signal 1236 can be degraded and attenuated by the communication channel 1228 and include noise. The receiver 1230 can output a received signal 1238, “v(n),” including the set of data symbols (e.g., symbols −3, −1, 1, 3, wherein the symbols represent coded binary data). In at least one embodiment, the transmitter 1226 can include the fast-recovery congestion control logic 106 as described herein. In at least one embodiment, the receiver 1230 can include the fast-recovery congestion control logic 106 as described herein.

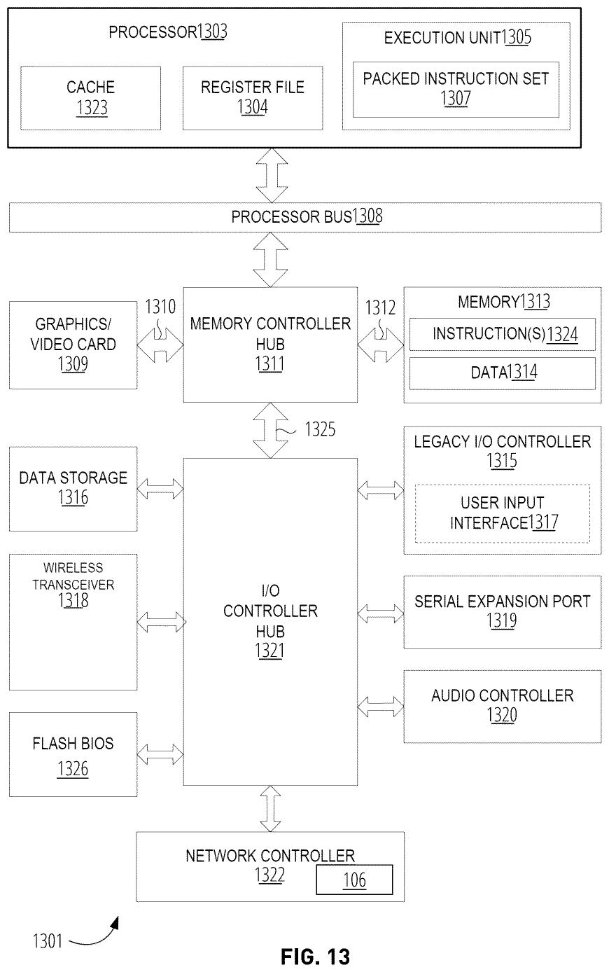

FIG. 13 illustrates an example computer system 1301, including fast-recovery congestion control logic 106, in accordance with at least some embodiments. In at least one embodiment, computer system 1301 may be a system with interconnected devices and components, an SOC, or some combination. In at least one embodiment, computer system 1301 is formed with a processor 1303 that may include execution units to execute an instruction. In at least one embodiment, computer system 1301 may include, without limitation, a component, such as a processor 1303, to employ execution units including logic to perform algorithms for processing data. In at least one embodiment, computer system 1301 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1301 may execute a version of WINDOWS′ operating system available from Microsoft Corporation of Redmond, Wash., although other operating systems (UNIX and Linux, for example), embedded software, and/or graphical user interfaces, may also be used.

In at least one embodiment, computer system 1301 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 1301 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 1301 may include, without limitation, processor 1303 that may include, without limitation, one or more execution units 1305 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1301 is a single processor desktop or server system. In at least one embodiment, computer system 1301 may be a multiprocessor system. In at least one embodiment, processor 1303 may include, without limitation, a CISC microprocessor, a RISC microprocessor, a VLIW microprocessor, and a processor implementing a combination of instruction sets, or any other processor device, such as a digital signal processor, for example. In at least one embodiment, processor 1303 may be coupled to a processor bus 1308 that may transmit data signals between processor 1303 and other components in computer system 1301.

In at least one embodiment, processor 1303 may include, without limitation, a Level 1 (“L1”) internal cache memory (“cache”) 1323. In at least one embodiment, processor 1303 may have a single internal cache or multiple levels of internal cache. In at least one embodiment, cache memory may reside externally to processor 1303. In at least one embodiment, processor 1303 may also include a combination of both internal and external caches. In at least one embodiment, a register file 1304 may store different types of data in various registers including, without limitation, integer registers, floating point registers, status registers, and instruction pointer registers.

In at least one embodiment, execution unit 1305, including, without limitation, logic to perform integer and floating point operations, also resides in processor 1303. Processor 1303 may also include a microcode (“ucode”) read only memory (“ROM”) that stores microcode for certain macro instructions. In at least one embodiment, execution unit 1305 may include logic to handle a packed instruction set 1307. In at least one embodiment, by including packed instruction set 1307 in an instruction set of a general-purpose processor 1303, along with associated circuitry to execute instructions, operations used by many multimedia applications may be performed using packed data in a general-purpose processor 1303. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1306 may also be used in microcontrollers, embedded processors, graphics devices, DSPs, and other types of logic circuits. In at least one embodiment, computer system 1301 may include, without limitation, a memory 1313. In at least one embodiment, memory 1313 may be implemented as a DRAM device, an SRAM device, flash memory device, or other memory devices. Memory 1313 may store instruction(s) 1324 and/or data 1314 represented by data signals that may be executed by processor 1303.

In at least one embodiment, a system logic chip may be coupled to a processor bus 1308 and memory 1313. In at least one embodiment, the system logic chip may include, without limitation, a memory controller hub (“MCH”) 1311, and processor 1303 may communicate with MCH 1311 via processor bus 1308. In at least one embodiment, MCH 1311 may provide a high bandwidth memory path 1312 to memory 1313 for instruction and data storage and for storage of graphics commands, data, and textures. In at least one embodiment, MCH 1311 may direct data signals between processor 1303, memory 1313, and other components in computer system 1301 and may bridge data signals between processor bus 1308, memory 1313, and a system I/O 1325. In at least one embodiment, a system logic chip may provide a graphics port for coupling to a graphics controller. In at least one embodiment, MCH 1311 may be coupled to memory 1313 through high bandwidth memory path 1312, and graphics/video card 1309 may be coupled to MCH 1311 through an Accelerated Graphics Port (“AGP”) interconnect 1310.

In at least one embodiment, computer system 1301 may use system I/O 1325 that is a proprietary hub interface bus to couple MCH 1311 to I/O controller hub (“ICH”) 1321. In at least one embodiment, ICH 1321 may provide direct connections to some I/O devices via a local I/O bus. In at least one embodiment, a local I/O bus may include, without limitation, a high-speed I/O bus for connecting peripherals to memory 1313, a chipset, and processor 1303. Examples may include, without limitation, an audio controller 1320, a firmware hub (“flash BIOS”) 726, a wireless transceiver 1318, a data storage 1316, a legacy I/O controller 1315 containing a user input interface 1317, a keyboard interface, a serial expansion port 1319, such as a USB, and a network controller 1322. In at least one embodiment, the network controller 1322 includes the fast-recovery congestion control logic 106. Data storage 1316 may comprise a hard disk drive, a floppy disk drive, a CD-ROM device, a flash memory device, or other mass storage device.

In at least one embodiment, FIG. 13 illustrates a system, which includes interconnected hardware devices or “chips.” In at least one embodiment, FIG. 13 may illustrate an example SoC. In at least one embodiment, devices illustrated in FIG. 13 may be interconnected with proprietary interconnects, standardized interconnects (e.g., PCIe), or some combination thereof. In at least one embodiment, one or more components of system 1302 are interconnected using compute express link (“CXL”) interconnects.

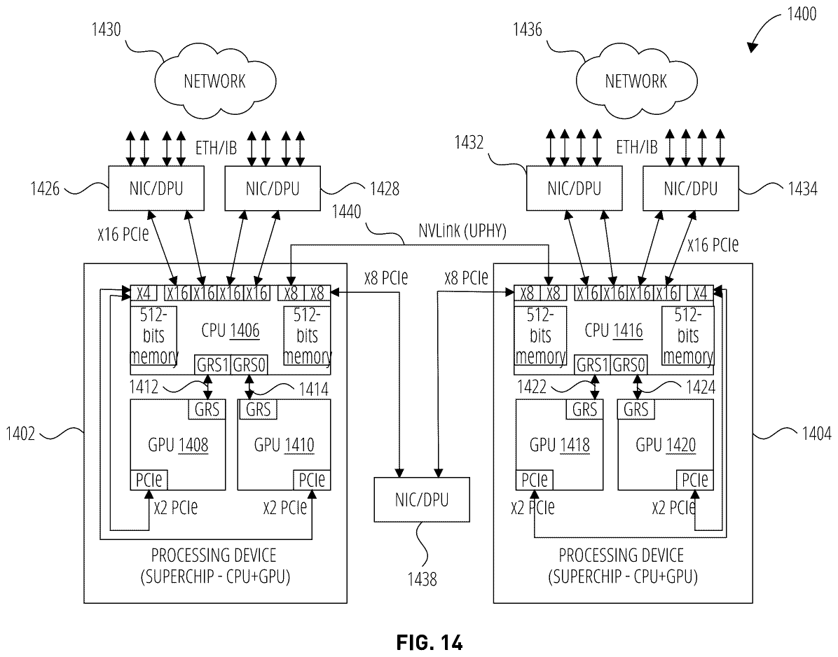

FIG. 14 is a block diagram of a computing system 1400 having two processing devices coupled to each other and multiple networks according to at least one embodiment. The computing system 1400 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 1400. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 1400 highly suitable for demanding applications that require significant processing power, such as artificial intelligence (AI), machine learning (ML), and data-intensive computing, while ensuring robust connectivity and scalability across various networked environments. The integrated circuits of the computing system 1400 can include one or more CPUs and one or more GPUs. An example architecture of a multi-GPU architecture is illustrated in FIG. 14.

As illustrated in FIG. 14, the computing system 1400 includes a processing device 1402 with a multi-GPU architecture. In particular, the processing device 1402 includes a CPU 1406, a GPU 1408, and a GPU 1410. The CPU 1406 can be coupled to the GPU 1408 via an die-to-die (D2D) or chip-to-chip (C2C) interconnect 1412, such as a Ground-Referenced Signaling interconnect (GRS interconnect). The CPU 1406 can be coupled to the GPU 1410 via a D2D or C2C interconnect 1414. The CPU 1406 can also be coupled to the GPU 1408 and GPU 1410 via PCIe interconnects. The CPU 1406 can be coupled to one or more network interface cards (NICs) or data processing units (DPUs), which are coupled to one or more networks. For example, as illustrated in FIG. 14, the CPU 1406 is coupled to a first NIC/DPU 1426, which is coupled to a network 1430. The CPU 1406 is also coupled to a second NIC/DPU 1428, which is coupled to the network 1430. The NIC/DPU 1426 and NIC/DPU 1428 can be coupled to the network 1430 over Ethernet (ETH) or InfiniBand (IB) connections.

The computing system 1400 also includes a processing device 1404 with a multi-GPU architecture. In particular, the processing device 1404 includes a CPU 1416, a GPU 1418, and a GPU 1420. The CPU 1416 can be coupled to the GPU 1418 via an D2D or C2C interconnect 1422. The CPU 1416 can be coupled to the GPU 1420 via a D2D or C2C interconnect 1424. The CPU 1416 can also be coupled to the GPU 1418 and GPU 1420 via PCIe interconnects. The CPU 1416 can be coupled to one or more NICs or DPUs, which are coupled to one or more networks. For example, as illustrated in FIG. 14, the CPU 1416 is coupled to a first NIC/DPU 1432, which is coupled to a network 1436. The CPU 1416 is also coupled to a second NIC/DPU 1434, which is coupled to the network 1436. The NIC/DPU 1432 and NIC/DPU 1434 can be coupled to the network 1436 over Ethernet (ETH) or InfiniBand (IB) connections.

In at least one embodiment, the processing device 1402 and the processing device 1404 can communicate with each other via a NIC/DPU 1438, such as over PCIe interconnects. The processing device 1402 and processing device 1404 can also communicate with each other over a high-bandwidth communication interconnects 1440, such as an NVLink interconnect or other high-speed interconnects. The NIC/DPUs of FIG. 14 can be the various embodiments of the DPUs described herein. The fast-recovery congestion control logic 106 can be implemented in any transmitter or receiver device of any of the devices described herein.

In at least one embodiment, the computing system 1400 is used for high-speed network communication and includes a processing unit (e.g., CPU 1406, GPU 1408, GPU 1410, CPU 1416, GPU 1418, GPU 1420, NIC/DPU 1426, NIC/DPU 1428, NIC/DPU 1432, NIC/DPU 1434, or NIC/DPU 1438), and a network interface coupled to the processing unit. The network interface can include the operations and functionality of the fast-recovery congestion control logic 106 described herein.

In at least one embodiment, a system for high-speed network communication includes a processing unit, and a network adapter coupled to the processing unit. The network adapter includes a receive (RX) pipeline, configured to receive packets from a network and process the received packets. The network comprising at least one switch between the first network adapter and a second network adapter. The network adapter includes a transmit (TX) pipeline, configured to transmit packets to the network. The network adapter includes congestion control (CC) circuitry coupled to the RX pipeline and TX pipeline, and a CC processor coupled to the CC circuitry. The CC processor can receive telemetry data associated with a RX port at the second network adapter. The CC processor can determine, using the telemetry data, a port utilization of the RX port. The CC processor can adjust, using the port utilization, a first transmission rate of a flow of packets to the second network adapter to a second transmission rate. The CC processor can cause the TX pipeline to transmit packets, directed to the second network adapter, at the second transmission rate. The processing unit can include a CPU, a GPU, a DPU, a deep learning accelerator, an inference accelerator, or the like.

In at least one embodiment, the computing system 1400 includes a host device and an auxiliary device. The auxiliary device includes a device memory and a processor, communicably coupled to the device memory. The auxiliary device performs the operations described herein with respect to FIG. 1 to FIG. 13. The auxiliary device can include a GPU. The auxiliary device can include a DPU. The auxiliary device can include a DPU. The auxiliary device can include accelerator hardware.

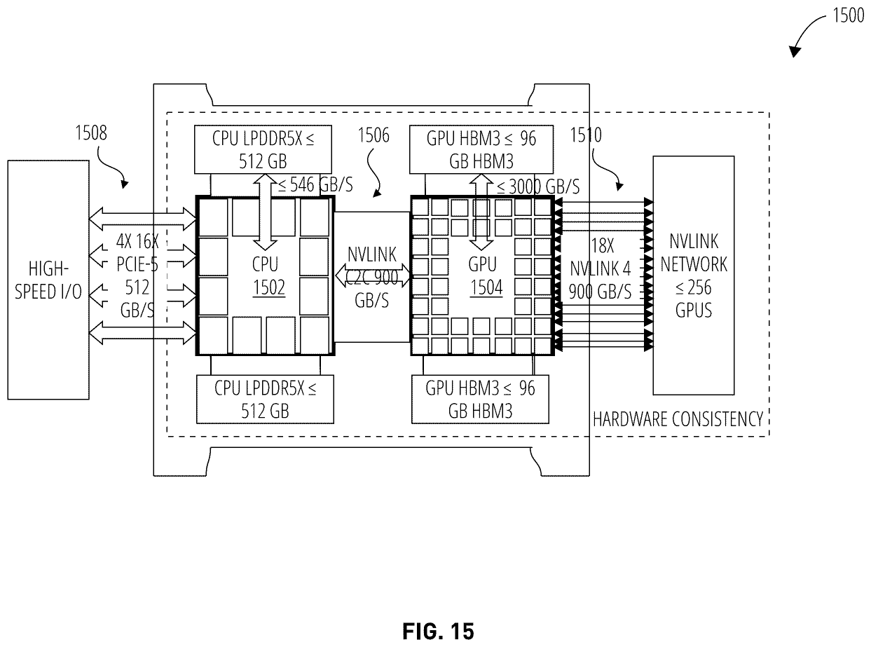

FIG. 15 is a block diagram of a computing system 1500 having a CPU 1502 and a GPU 1504 in a single integrated circuit according to at least one embodiment. The computing system 1500 can be a highly integrated design where a CPU 1502 and GPU 1504 are connected on a single integrated circuit, utilizing an NVLink C2C (Chip-to-Chip) interconnect 1506 to enable fast, low-latency communication between the two processing units. This close integration allows for efficient data transfer and parallel processing between the CPU 1502 and GPU 1504, optimizing performance for complex computational tasks. The GPU elements within the computing system 1500 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1510. Additionally, the computing system 1500 can be designed to interface with a high-speed I/O through PCIe interconnects 1508, ensuring rapid data transfer to and from external devices, further enhancing the system's capabilities in handling data-intensive tasks and providing robust connectivity to peripheral components. It should be noted that the C2C interconnects 1506 can be considered D2D interconnects since the CPU 1502 and the GPU 1504 are located on the same integrated circuit. The integrated circuit can include CPU memory (also referred to as main memory) and GPU memory, which are accessible by the CPU 1502 and the GPU 1504, respectively, over high-speed interconnects. The computing system 1500 can bring together performance of the GPU 1504 with the versatility of the CPU 1502. The CPU 1502 can be connected with a high-bandwidth and memory coherent C2C interconnects 1506 in a single integrated circuit. The computing system 1500 can support a link switch system.

The computing system 1500 can include the fast-recovery congestion control logic 106 used for the various embodiments described herein with respect to FIG. 1 to FIG. 14. The fast-recovery congestion control logic 106 can be implemented in any of the devices described herein.

In at least one embodiment, the computing system 1500 is used for high-speed network communication and includes a processing unit, and a network interface coupled to the processing unit. The network interface can include the operations and functionality of the DPUs described herein.

In at least one embodiment, the computing system 1500 includes a host device and an auxiliary device. The auxiliary device includes a device memory and a processor, communicably coupled to the device memory. The auxiliary device performs the operations described herein with respect to FIG. 1 to FIG. 14. The auxiliary device can include a GPU. The auxiliary device can include a DPU. The auxiliary device can include a DPU. The auxiliary device can include accelerator hardware.

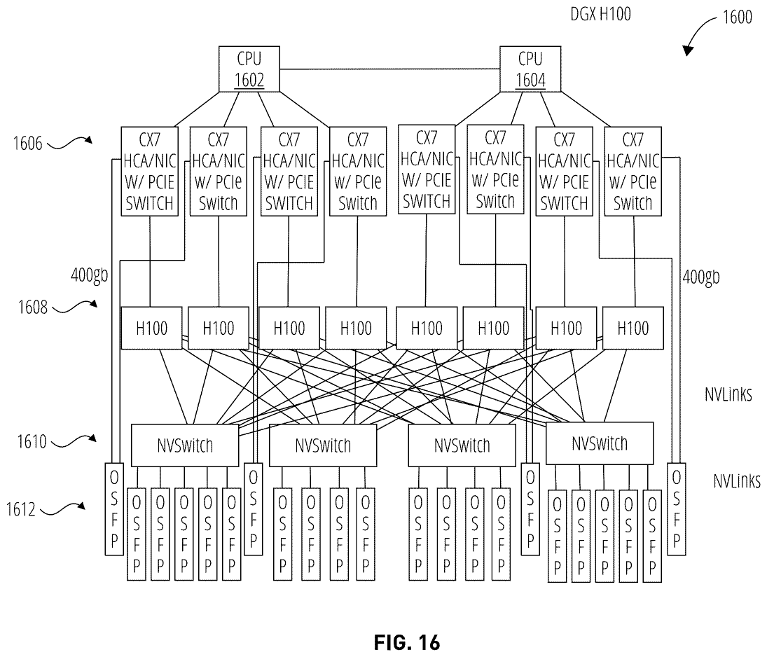

FIG. 16 is a block diagram of a computing system 1600 having tensor core GPUs 1608 according to at least one embodiment. The computing system 1600 can be a DGX H100 system, which is a high-performance computing platform designed to meet the demands of AI, ML, and deep learning (DL) workloads. The computing system 1600 can include multiple tensor core GPUs 1608 (e.g., NVIDIA H100 Tensor Core GPUs). The tensor core GPUs 1608 can each be one of the integrated circuits described above with respect to FIG. 15. The tensor core GPUs 1608 can be optimized for AI/ML/DL applications, offering exceptional performance for deep learning training, inference, and high-performance computing tasks. The tensor core GPUs 1608 within the computing system 1600 are interconnected using high-speed communication interfaces like NVLinks, enabling rapid data transfer between them, which is crucial for handling large-scale AI models and datasets with low latency. This computing system 1600 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1608, the computing system 1600 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1608 for their specific applications. The computing system 1600 is ideally suited for large-scale AI model training, real-time inference, scientific simulations, data analytics, and other compute-intensive tasks that require massive parallel processing power.

The tensor core GPUs 1608 can be coupled to multiple CPUs, such as CPU 1602 and CPU 1604, using switches 1606 (e.g., CX7 HCA/NIC with PCIe switch). The tensor core GPUs 1608 can be coupled to each other via switches 1610 (e.g., NVSwitches). The switches 1606 and switches 1610 can be coupled to high-speed transceiver modules 1612. The high-speed transceiver modules 1612 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1600 remains capable of meeting increasing data demands and can be upgraded to support future advancements in network speeds, thus contributing to the system's overall performance and scalability.

In at least one embodiment, the computing system 1600 can be considered a data-network configuration with full-bandwidth intra-server NVLinks. In this example, all eight tensor core GPUs 1608 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1608 can half-subscribe eighteen NVLinks to GPUs in other servers. Four tensor core GPUs 1608 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1608 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1600 can include the fast-recovery congestion control logic 106 as described in the various embodiments described herein with respect to FIG. 1 to FIG. 15.

In at least one embodiment, the computing system 1600 is used for high-speed network communication and includes a processing unit (e.g., CPU 1602, CPU 1604, switches 1606, tensor core GPUs 1608, switches 1610, high-speed transceiver modules 1612), and a network adapter coupled to the processing unit. The network adapter can perform the corresponding operations and functionalities described herein. The processing unit can include a CPU, a GPU, a DPU, a deep learning accelerator, an inference accelerator, or the like.

In at least one embodiment, the computing system 1600 includes a host device and an auxiliary device. The auxiliary device includes a device memory and a processor, communicably coupled to the device memory. The auxiliary device performs the operations described herein with respect to FIG. 1 to FIG. 15. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors-for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A first network device comprising:
a network interface to send first packets of a flow of packets at a first transmission rate over a network to a second network device via a switch; and
packet processing circuitry coupled to the network interface, the packet processing circuitry to:
receive telemetry data collected by the second network device;
determine, using the telemetry data, a positive congestion indication of the flow of packets;
adjust, using the positive congestion indication, the first transmission rate to a second transmission rate; and
cause the network interface to send second packets of the flow of packets at the second transmission rate over the network to the second network device via the switch.

2. The first network device of claim 1, wherein the second transmission rate is higher than the first transmission rate.

3. The first network device of claim 1, wherein the positive congestion indication is a receive (RX) port utilization metric of an RX port at the second network device.

4. The first network device of claim 1, wherein the telemetry data comprises a receive (RX) port utilization metric of an RX port at the second network device.

5. The first network device of claim 1, wherein the telemetry data comprises a receive (RX) byte count, a timestamp, and a link speed associated with a RX port at the second network device, and wherein the packet processing circuitry is to determine an RX port utilization metric of the RX port using the RX byte count, the timestamp, and the link speed.

6. The first network device of claim 1, wherein the packet processing circuitry is to receive the telemetry data in a response to a probe packet previously sent by the first network device.

7. The first network device of claim 1, wherein the packet processing circuitry comprises:
congestion control (CC) circuitry coupled to the network interface, the CC circuitry to control transmission rates of different flows of packets; and
a CC processor coupled to the CC circuitry, wherein the CC processor is configured to execute instructions to receive the telemetry data, determine the positive congestion indication, and cause the CC circuitry to adjust the first transmission rate to the second transmission rate for the flow of packets, and wherein the CC circuitry is to cause the network interface to send the second packets of the flow of packets at the second transmission rate over the network to the second network device via the switch.

8. A first network adapter comprising:
a receive (RX) pipeline, configured to receive packets from a network and process the received packets, the network comprising at least one switch between the first network adapter and a second network adapter;
a transmit (TX) pipeline, configured to transmit packets to the network;
congestion control (CC) circuitry coupled to the RX pipeline and TX pipeline; and
a CC processor coupled to the CC circuitry, wherein the CC processor is to:
receive telemetry data associated with a RX port at the second network adapter;
determine, using the telemetry data, a port utilization of the RX port;
adjust, using the port utilization, a first transmission rate of a flow of packets to the second network adapter to a second transmission rate; and
cause the TX pipeline to transmit packets, directed to the second network adapter, at the second transmission rate.

9. The first network adapter of claim 8, wherein the second transmission rate is higher than the first transmission rate.

10. The first network adapter of claim 8, wherein the telemetry data comprises a RX port utilization metric of the RX port, and wherein the CC processor is to determine the port utilization using the RX port utilization metric.

11. The first network adapter of claim 8, wherein the telemetry data comprises an RX byte count, a timestamp, and a link speed associated with the RX port, and wherein the CC processor is to determine the port utilization of the RX port using the RX byte count, the timestamp, and the link speed.

12. The first network adapter of claim 8, wherein the CC processor is to receive the telemetry data in a response to a probe packet previously sent by the first network adapter.

13. A method of operating a first network device, the method comprising:
sending first packets of a flow of packets at a first transmission rate over a network to a second network device via a switch;
receiving telemetry data collected by the second network device;
determining, using the telemetry data, a positive congestion indication of the flow of packets;
adjusting, using the positive congestion indication, the first transmission rate to a second transmission rate; and
sending second packets of the flow of packets at the second transmission rate over the network to the second network device via the switch.

14. The method of claim 13, wherein the second transmission rate is higher than the first transmission rate.

15. The method of claim 13, wherein the positive congestion indication is a receive (RX) port utilization metric of an RX port at the second network device.

16. The method of claim 13, wherein the telemetry data comprises a receive (RX) port utilization metric of an RX port at the second network device.

17. The method of claim 13, wherein the telemetry data comprises a receive (RX) byte count, a timestamp, and a link speed associated with a RX port at the second network device, and wherein the method further comprises determining an RX port utilization metric of the RX port using the RX byte count, the timestamp, and the link speed.

18. The method of claim 13, wherein receiving the telemetry data comprises receiving the telemetry data in a response to a probe packet previously sent by the first network device.

19. A system for high-speed network communication, the system comprising:
a processing unit; and
a network adapter coupled to the processing unit, wherein the network adapter comprises:
a receive (RX) pipeline, configured to receive packets from a network and process the received packets, the network comprising at least one switch between the network adapter and a second network adapter;
a transmit (TX) pipeline, configured to transmit packets to the network;
congestion control (CC) circuitry coupled to the RX pipeline and TX pipeline; and
a CC processor coupled to the CC circuitry, wherein the CC processor is to:
receive telemetry data associated with a RX port at the second network adapter;
determine, using the telemetry data, a port utilization of the RX port;
adjust, using the port utilization, a first transmission rate of a flow of packets to the second network adapter to a second transmission rate; and
cause the TX pipeline to transmit packets, directed to the second network adapter, at the second transmission rate.

20. The system of claim 19, wherein the processing unit comprises at least one of a central processing unit (CPU), a graphics processing unit (GPU), a deep learning accelerator, or an inference accelerator.
